(19) United States
(12) Patent Application Publication
(10) Pub. No.: US 2003/0154826 A1
(43) Pub. Date: Aug. 21, 2003

(54) Connector structure of a ratchet wrench

(76) Inventor: Daniel Lee, Tali City (TW)

Correspondence Address: Hart, Baxley, Daniels & Holton, Fifth Floor, 59 John Street, New York, NY, 10038, US

(21) Appl. No.: 10/079,308

(22) Filed: Feb. 21, 2002

(51) Int. Cl. B25B 13/46

(52) U.S. Cl. 81/63.1

(57) ABSTRACT

The present invention relates to a connector structure for a ratchet wrench. The ratchet wrench includes a wrench body having a distal end provided with a ratchet wheel. The connector structure includes a connector secured in the ratchet wheel, a retaining member secured on an upper portion of the connector and rested on a top of the ratchet wheel, and a washer secured in the inner wall of the connector. Thus, the ratchet wrench may be used to operate and rotate a screwdriver or a socket by co-operation of the connector of the connector structure, thereby greatly enhancing the versatility of the ratchet wrench.

### BACKGROUND OF THE INVENTION

1. Field of the Invention

The present invention relates to a connector structure of a ratchet wrench, and more particularly to a connector structure of a ratchet wrench, wherein the ratchet wrench may be used to operate and rotate a screwdriver by co-operation of the connector of the connector structure, thereby enhancing the versatility of the ratchet wrench.

2. Description of the Related Art

A conventional ratchet wrench in accordance with the prior art may co-operate with a socket to operate and rotate a workpiece, such as a hexagonal bolt or nut. However, the conventional ratchet wrench cannot be used to operate or rotate a screwdriver, thereby limiting the versatility of the ratchet wrench.

### SUMMARY OF THE INVENTION

The present invention has arisen to mitigate and/or obviate the disadvantage of the conventional ratchet wrench.

The primary objective of the present invention is to provide a connector structure of a ratchet wrench, wherein the ratchet wrench may be used to operate and rotate the screwdriver or the socket by co-operation of the connector of the connector structure, thereby enhancing the versatility of the ratchet wrench.

Another objective of the present invention is to provide a connector structure of a ratchet wrench, wherein the retaining member is secured in the retaining notches of the upper portion of the connector, so that the connector may be secured in the ratchet wheel, thereby preventing the connector from being detached from the ratchet wheel.

A further objective of the present invention is to provide a connector structure of a ratchet wrench, wherein the washer is secured in the annular groove of the connector, so that the screwdriver or the shank may be secured in the receiving chamber of the connector rigidly and stably.

In accordance with the present invention, there is provided a connector structure in combination with a ratchet wrench, wherein:

the ratchet wrench includes a wrench body having a distal end provided with a ratchet wheel; and

the connector structure comprises a connector secured in the ratchet wheel.

Preferably, the connector has a substantially hexagonal shape.

Preferably, the connector has an inner wall formed with a receiving chamber.

Preferably, the receiving chamber of the connector has a substantially hexagonal shape.

The connector structure of a ratchet wrench further comprises a retaining member secured on an upper portion of the connector, and rested on a top of the ratchet wheel.

Preferably, the upper portion of the connector is protruded outward from the top of the ratchet wheel and is formed with multiple retaining notches, and the retaining member is secured in the retaining notches of the upper portion of the connector.

Preferably, the retaining member is a C-shaped snap ring.

Preferably, the connector has a lower portion formed an annular stop flange rested on a bottom of the ratchet wheel.

The connector structure of a ratchet wrench further comprises a washer secured in an inner wall of the connector.

Preferably, the inner wall of the connector is formed with an annular groove for retaining the washer.

Preferably, the washer is substantially C-shaped.

Further benefits and advantages of the present invention will become apparent after a careful reading of the detailed description with appropriate reference to the accompanying drawings,

### BRIEF DESCRIPTION OF THE DRAWINGS

FIG. 1 is a perspective view of a connector structure of a ratchet wrench in accordance with a preferred embodiment of the present invention;

FIG. 2 is an exploded perspective view of the connector structure of a ratchet wrench in accordance with a preferred embodiment of the present invention;

FIG. 3 is a side plan cross-sectional assembly view of the connector structure of a ratchet wrench as shown in FIG. 1; and

FIG. 4 is a perspective view of a connector structure of a ratchet wrench in accordance with another preferred embodiment of the present invention.

### DETAILED DESCRIPTION OF THE INVENTION

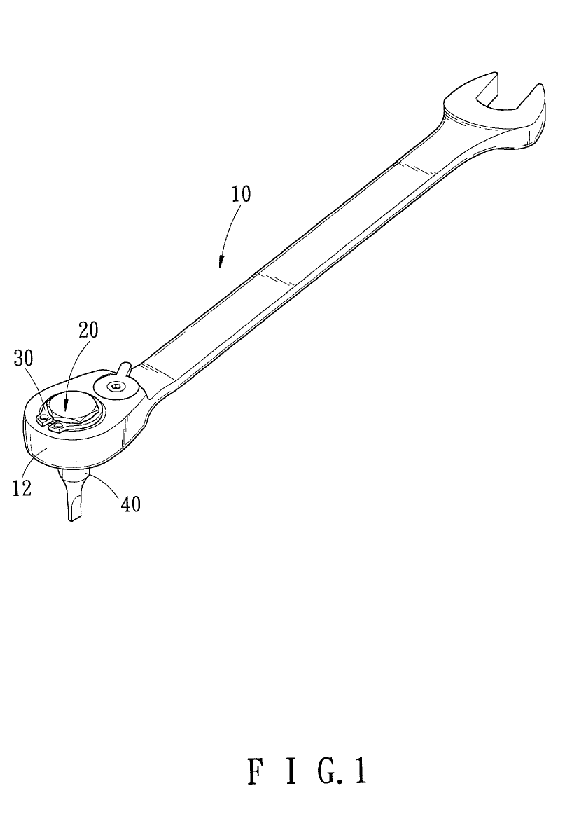

Referring to the drawings and initially to FIGS. 1-3, a connector structure of a ratchet wrench in accordance with a preferred embodiment of the present invention is shown.

The ratchet wrench includes a wrench body 10 having a distal end provided with a drive head 12, a ratchet wheel 14 rotatably mounted in the drive head 12 and having an inner wall provided with multiple of ratchet teeth 140, and a control knob 16 mounted on the drive head 12 for controlling the direction of rotation of the ratchet wheel 14.

The connector structure of a ratchet wrench in accordance with a preferred embodiment of the present invention comprises a connector 20, a retaining member 30, and a washer 32.

The connector 20 is secured in the ratchet wheel 14, and has an inner wall formed with a receiving chamber 22. Preferably, the connector 20 has a substantially hexagonal shape, and the receiving chamber 22 of the connector 20 has a substantially hexagonal shape. The connector 20 has an upper portion protruded outward from a top of the ratchet wheel 14 and formed with multiple retaining notches 24, and a lower portion formed an annular stop flange 26 rested on a bottom of the ratchet wheel 14. The inner wall of the connector 20 is formed with an annular groove 28.

The retaining member 30 is secured in the retaining notches 24 of the upper portion of the connector 20, and is rested on the top of the ratchet wheel 14. Preferably, the retaining member 30 is a C-shaped snap ring.

The washer 32 is secured in the annular groove 28 of the connector 30. Preferably, the washer 32 is substantially C-shaped.

In assembly, the connector 20 is inserted into the ratchet wheel 14, with the annular stop flange 26 of the connector 20 being rested on a bottom of the ratchet wheel 14, and with the upper portion of the connector 20 being protruded outward from the top of the ratchet wheel 14. Then, the retaining member 30 is secured in the retaining notches 24 of the upper portion of the connector 20, so that the connector 20 may be secured in the ratchet wheel 14.

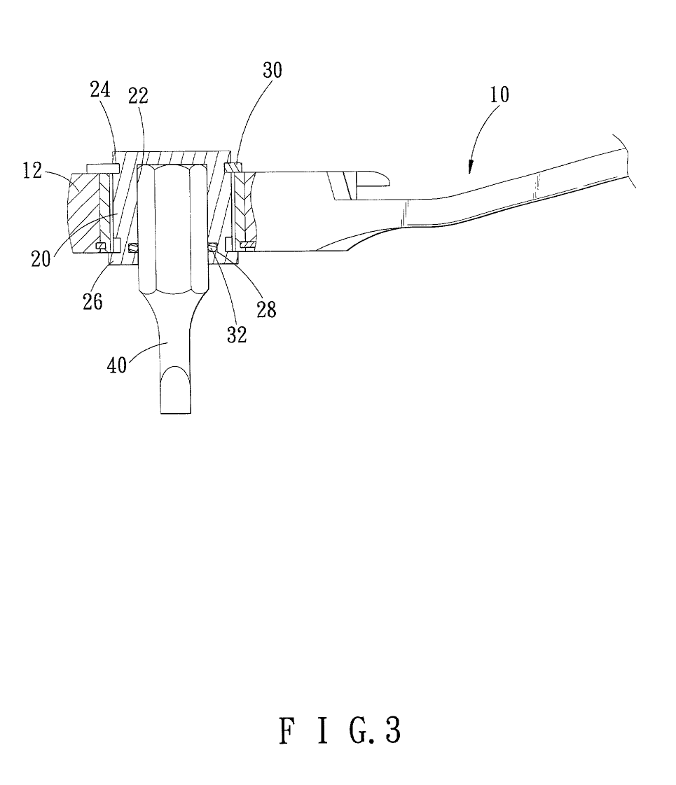

In operation, a screwdriver 40 may be inserted into and secured in the receiving chamber 22 of the connector 20 as shown in FIG. 3, so that the drive head 12 of the wrench body 10 of the ratchet wrench may be used to operate and rotate the screwdriver 40 by the connector 20 of the connector structure in accordance with a preferred embodiment of the present invention.

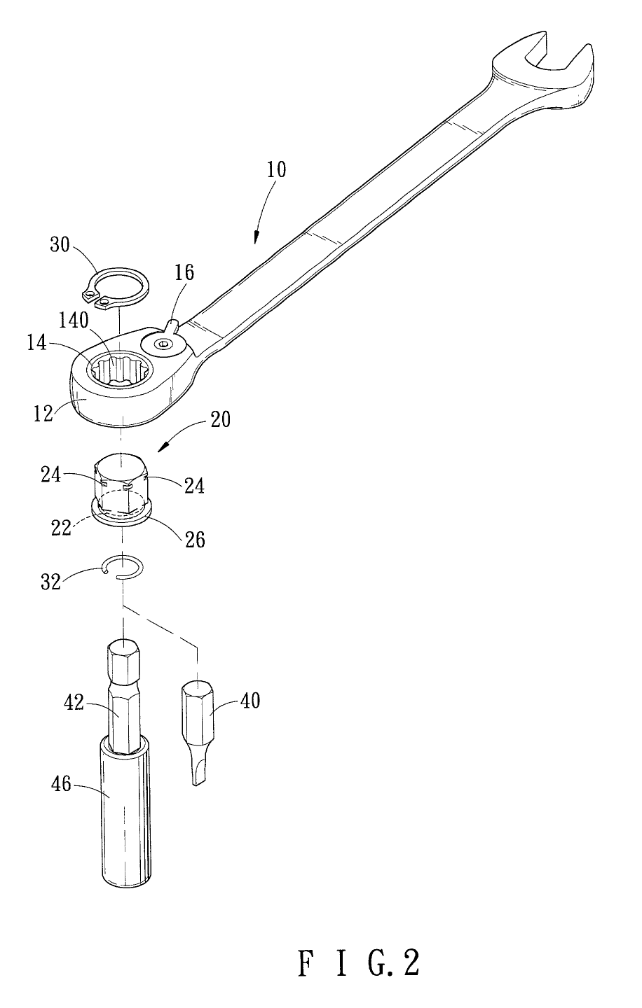

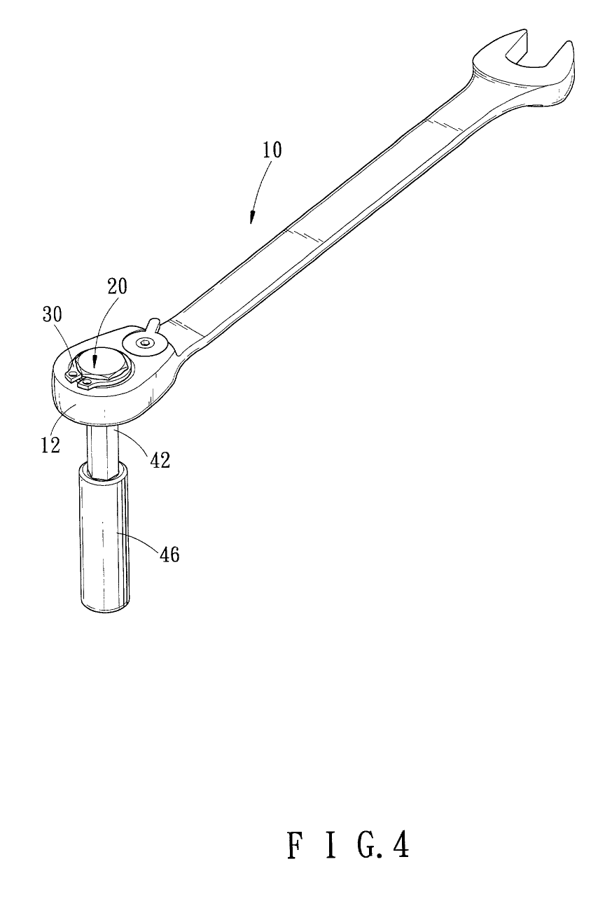

Referring to FIGS. 2 and 4, a shank 42 may be inserted into and secured in the receiving chamber 22 of the connector 20, and a socket 46 may be secured on the shank 42, so that the drive head 12 of the wrench body 10 of the ratchet wrench may be used to operate and rotate the socket 46 by the connector 20 of the connector structure in accordance with a preferred embodiment of the present invention.

Accordingly, in the connector structure in accordance with a preferred embodiment of the present invention, the ratchet wrench may be used to operate and rotate the screwdriver 49 or the socket 46 by co-operation of the connector 20 of the connector structure, thereby enhancing the versatility of the ratchet wrench. In addition, the retaining member 30 is secured in the retaining notches 24 of the upper portion of the connector 20, so that the connector 20 may be secured in the ratchet wheel 14, thereby preventing the connector 20 from being detached from the ratchet wheel 14. Further, the washer 32 is secured in the annular groove 28 of the connector 30, so that the screwdriver 40 or the shank 42 may be secured in the receiving chamber 22 of the connector 20 rigidly and stably.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. A connector structure in combination with a ratchet wrench, wherein:
the ratchet wrench includes a wrench body having a distal end provided with a ratchet wheel; and
the connector structure comprises a connector secured in the ratchet wheel.

2. The connector structure of a ratchet wrench in accordance with claim 1, wherein the connector has a substantially hexagonal shape.

3. The connector structure of a ratchet wrench in accordance with claim 1, wherein the connector has an inner wall formed with a receiving chamber.

4. The connector structure of a ratchet wrench in accordance with claim 3, wherein the receiving chamber of the connector has a substantially hexagonal shape.

5. The connector structure of a ratchet wrench in accordance with claim 1, further comprising a retaining member secured on an upper portion of the connector, and rested on a top of the ratchet wheel.

6. The connector structure of a ratchet wrench in accordance with claim 5, wherein the upper portion of the connector is protruded outward from the top of the ratchet wheel and is formed with multiple retaining notches, and the retaining member is secured in the retaining notches of the upper portion of the connector.

7. The connector structure of a ratchet wrench in accordance with claim 5, wherein the retaining member is a C-shaped snap ring.

8. The connector structure of a ratchet wrench in accordance with claim 1, wherein the connector has a lower portion formed an annular stop flange rested on a bottom of the ratchet wheel.

9. The connector structure of a ratchet wrench in accordance with claim 1, further comprising a washer secured in an inner wall of the connector.

10. The connector structure of a ratchet wrench in accordance with claim 9, wherein the inner wall of the connector is formed with an annular groove for retaining the washer.

11. The connector structure of a ratchet wrench in accordance with claim 9, wherein the washer is substantially C-shaped.
